(19) United States
(12) Patent Application Publication
(10) Pub. No.: US 2006/0095584 A1
(43) Pub. Date: May 4, 2006

(54) Semantic-based switch fabric OS

(75) Inventors: Vikas Deolaliker, Sunnyvale, CA (US); Udayakumar Subbarayan, Santa Clara, CA (US); Liuxi Yang, Sunnyvale, CA (US); Jay Sethuram, Los Altos, CA (US)

Correspondence Address: Fernandez & Associates, LLP, PO Box D, Menlo Park, CA, 94025-6204, US

(73) Assignee: Sonoa Systems, Inc., Santa Clara, CA (US)

(21) Appl. No.: 10/988,114

(22) Filed: Nov. 12, 2004

(51) Int. Cl. G06F 15/173

(52) U.S. Cl. 709/240

(57) ABSTRACT

A operating system creates a semantic-based platform or fabric that provides a service oriented network. The operating system assigns virtual addresses to services registered with the network. Messages for the services are sent by service requesters using their virtual addresses. The virtual address is then mapped to the actual address of the service provider, which is then sent to the intended service provider. The messages are processed according to an SOA stack, where messages can be routed at the virtual IP, transport, or message layer without the need to process the message at the IP layer. The web services can be classified into a service zone, with the zone exposed to a service requester as a single entity. The zone is an independent domain, with communication within the zone managed by a semantic-based switch in the switch fabric.

### BACKGROUND

1. Field

The present invention relates to networks for web services, and more particularly to a network operating system for creating a network fabric for deployment of web services

2. Related Art

A “web service” is a network accessible interface to compute resources which can include applications, appliances or peripherals. The use of web services to access computer resources has been and will continue to increase in its popularity primarily because web services interfaces are defined using open industry standard protocols such as Simple Object Access Protocol (SOAP), Web Service Definition Language (WSDL) and Universal Description Discovery and Integration (UDDI). All of these protocols are encoded in an open industry standard data description language called extensible markup language or XML. Web Services enable access to computer resources at a granularity determined by the resource owner. For example, one could enable a subset of application functionality called “fine grained” web service or a superset of application functionality called “coarse grained” web service.

The web services protocols use existing transport mechanisms for communication. The SOAP protocol which is the “wire” protocol of web services uses HTTP protocol commonly used on the Internet as transport. FIG. 1 shows the protocol stack of the conventional web services infrastructure. The purpose of a layer in any network protocol stack is to resolve between two entities at the same layer. The SOAP protocol resolves among web services' entities while the IP protocol resolves among IP nodes (computers, printers etc.) at the IP layer of the network. One difference between the IP layer and the SOAP layer is the encoding mechanism for protocol units. At the IP layer, a protocol unit is called a “packet” and has binary encoding i.e. bits and bytes. On the other hand, at the SOAP layer, the unit is called an “envelope” and it is encoded in human readable text format.

FIG. 2 illustrates a high-level model of the conventional web service architecture, also known as “Publish, Find and Bind”. The “service provider” publishes a description of the service(s) it offers via the “service registry”. For any “service requester” (application) that needs to use certain web service functionalities, the requester service queries the registry for services that match its specific needs, and obtains information encoded in XML called WSDL that is needed to access the service at the provider. This process is known as the “discovery” or “find” phase. The next phase is the “invocation” or “bind” phase where the requesting service uses the WSDL interface description of the service to invoke the service which is resident on the provider. Note that during the discovery and the invocation phases, the developer is not involved. This is the essence of web services i.e. the service requester software discovers a service and it's location via a registry and dynamically binds to that service. This communication between the service requester, registry and the service provider is done through the exchange of SOAP message envelopes.

FIG. 3 illustrates a conventional datacenter infrastructure implementing the web services model. The web services are resident on the application servers 305. The registry manifests itself as a separate UDDI server 309 with an attached relational database 310. The actual applications are resident on the last row of servers 307 which are attached to mission critical enterprise data 308. This is called the three tier architecture as there is a tier for access, a tier for presentation, session management and business logic, and a tier for applications and databases. The three tiers are interconnected using layer 2 switches 304 and layer 3 switches 306. A typical web services' dynamic starts with a requesting service querying the service registry and getting a response in a WSDL file that contains the information the service requester needs to invoke the service. Armed with this information, the service requester 301 sends a message envelope to request the service from the service provider. The message can be of any type supported by the network, such as a Simple Object Access Protocol (SOAP) message. The service provider performs the requested task and returns the results to the service requester 301.

The policy and security functions are implemented on top of the web services by the policy server 311 and the security server 312, respectively. The policy and security are implemented as intermediary functions applied to web services' traffic as it goes from service requester 301 to service provider 307. System logging is a critical security task. A central logging server 313 is usually used to monitor all the web-service activities.

In the current infrastructure, neither the layer 2 switches 304 nor the layer 3 switches 306 are able to resolve two web services endpoints as two separate entities. Being lower in the web service protocol stack (FIG. 1), they are only able to resolve two entities as separate based on link addresses and/or IP addresses. A typical Layer 2/3 switch inspects the header of a packet that comes on the incoming port and performs a matching function to find the outgoing port. It is for this limited resolution ability of the switch that in today's web services' infrastructure, the role of the switch is quite limited.

There are several shortcomings of the conventional web services infrastructure. To support large amounts of service requesters, the same service functionality is replicated among multiple application servers. In addition to enforcing the policy and security, the web services intermediaries too are replicated or run on clusters to handle the increasing traffic. The cost of the added application servers and the intermediaries is prohibitive to a datacenter operator. Besides the expense of adding servers, current infrastructure's architecture is inefficient in at least five different ways:

First, since all discovery requests are routed to a UDDI server 309, this quickly becomes a bottleneck. Besides the performance shortfall, many times a service dies after registering, causing the registry database to become stale.

Second, inefficiency results from having to add intermediary servers to a datacenter to implement intermediary functions such as logging and metering of traffic, and security and policy enforcement. Functionalities such as these are better done in a network instead of at the end points.

Third, the current routing/switching infrastructure is unable to resolve entities at the web service's layer. Had the routing infrastructure been able to resolve two web services as two separate entities, the router could have routed the traffic as per the policy requirements.

Fourth, inefficiency results from having multiplicity of servers related to just one application. As the administration of the application needs to be centralized having this infrastructure sprawl of intermediary servers significantly adds to the cost of management of the datacenter.

Fifth, since the current architecture of the application server 305 includes the functions such as session management, protocol conversion and proxying, traffic in the datacenter is inefficiently routed because all traffic needs to go through the application server 305 many times in just one session.

Accordingly, there exists a need for an intelligent, semantic-based switch fabric operating system providing a service oriented network. The switch fabric operating system should be capable of resolving two web services entities in the network itself and be able to route traffic among these entities based on a policy set by the enterprise. It should also incorporate functionalities that currently run on the servers and result in traffic inefficiencies. These functionalities include security, policy, session management, protocol conversion, discovery acceleration and proxying. Having a fabric built through use of this kind of intelligent switch would significantly improve the performance, availability and scalability of web service's infrastructure. The present invention addresses such a need.

### SUMMARY

A operating system creates a semantic-based platform or fabric that provides a service oriented network. The operating system assigns virtual addresses to services registered with the network. Messages for the services are sent by service requesters using their virtual addresses. The virtual address is then mapped to the actual address of the service provider, which is then sent to the intended service provider. The messages are processed according to an SOA stack, which includes a virtual IP layer overlaid on an IP layer, a transport protocol layer, and a message protocol layer. The messages can be routed at the virtual IP, transport, or message layer without the need to process the message at the IP layer. The web services can be classified into a service zone, with the zone exposed to a service requester as a single entity. The zone is an independent domain, with communication within the zone managed by a semantic-based switch in the switch fabric.

### BRIEF DESCRIPTION OF DRAWINGS

FIG. 1 illustrates a protocol stack and the position of the SOAP protocol in that stack.

FIG. 2 illustrates a high-level model of the conventional web service architecture.

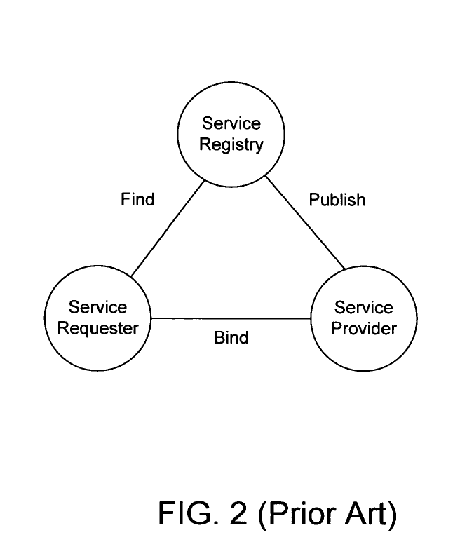

FIG. 3 illustrates a conventional network implementing the web services model.

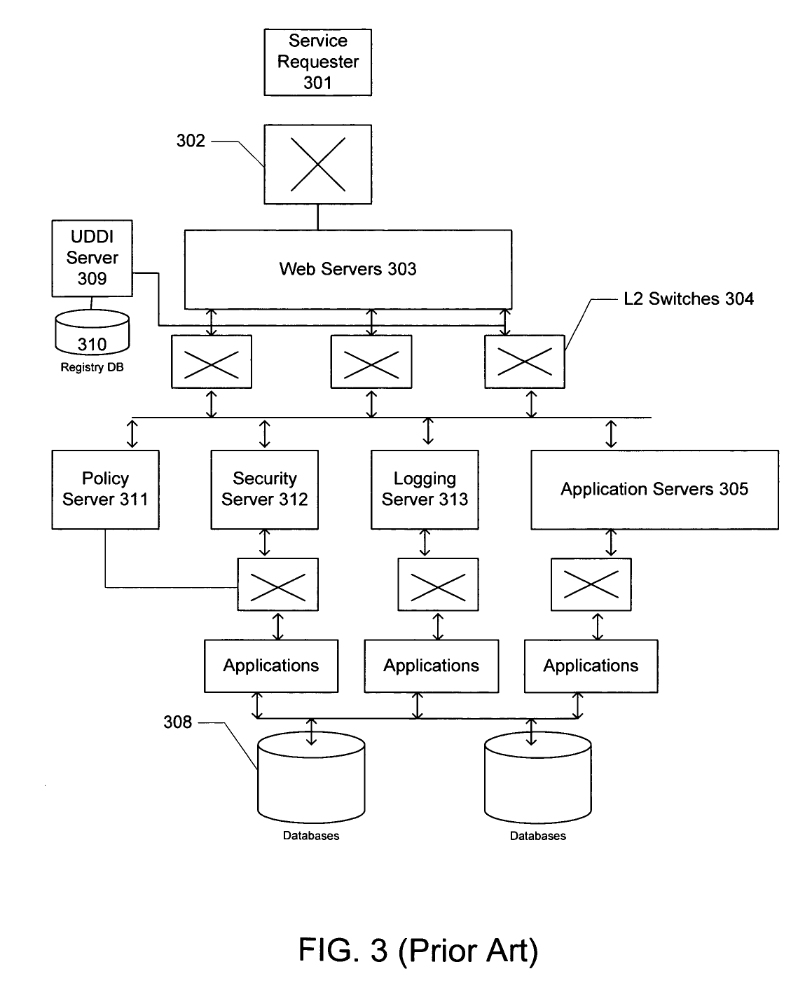

FIG. 4 illustrates a preferred embodiment of a semantic-based switch fabric created using semantic-based switches in accordance with the present invention.

FIG. 5 illustrates a preferred embodiment of a semantic-based switch in accordance with the present invention.

FIG. 6 illustrates a preferred embodiment of the tables for managing virtual addresses in accordance with the present invention.

FIG. 7 is a flowchart illustrates the assignment of a gateway to a service requester by the switch fabric operating system.

FIG. 8 illustrates a preferred embodiment of a service-oriented architecture stack in accordance with the present invention.

FIG. 9 illustrates the classifying of web services into service zones in accordance with the present invention.

FIG. 10 illustrates the layers for enabling a service zone in accordance with the present invention.

### DETAILED DESCRIPTION

The present invention provides an intelligent, semantic-based switch fabric operating system providing a service oriented network. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown but is to be accorded the widest scope consistent with the principles and features described herein.

Switch Fabric

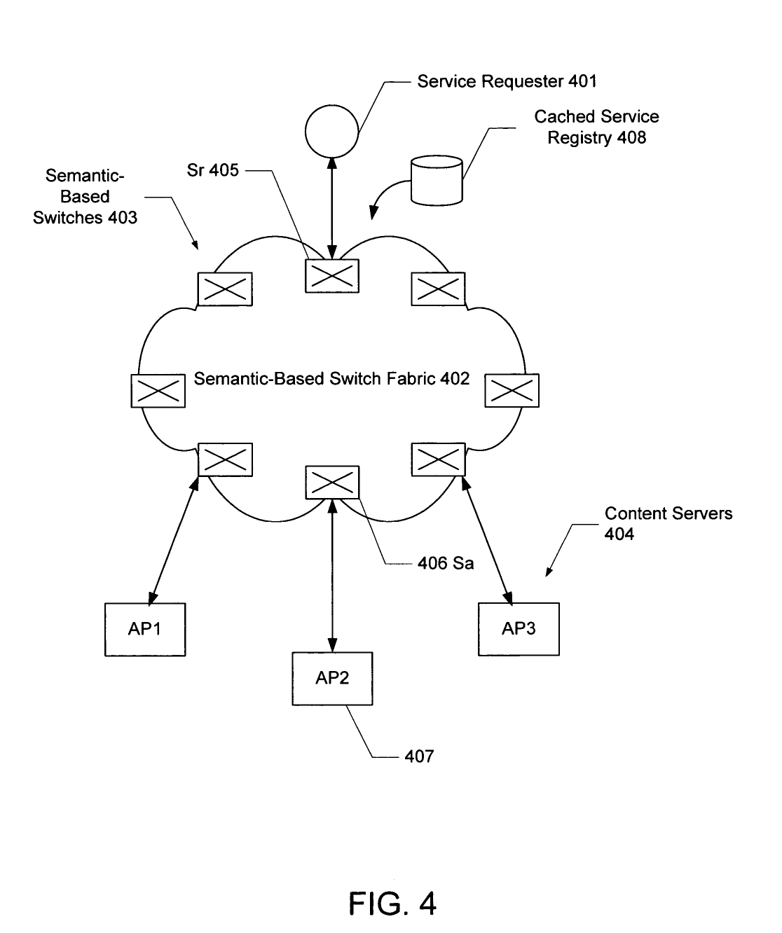

FIG. 4 illustrates a preferred embodiment of a semantic-based switch fabric provided by the operating system in accordance with the present invention. The semantic-based switch fabric 402 includes a plurality of semantic-based switches 403, each of which is capable of providing routing, security, policy, load balancing, registry caching, protocol conversion, session management and proxying functionalities. Each switch 403 fully supports a service lifecycle which includes authentication, registry lookup (discovery), reliable message routing, protocol and data transformation, and logging & metering. Thus, the semantic-based switch fabric 402 in accordance with the present invention provides a service oriented network (SON).

The fabric 402 further includes a cached service registry 408. The registry aids in the discovery of a service. It allows the switch 403 to organize the service's location hierarchically on any dimension, often referred to as “ontology”. The switch 403 can cache the service location information close to the service requester based on traffic patterns. The switch 403 can itself talk to the registry database and become a full fledged proxy server for the UDDI registry server.

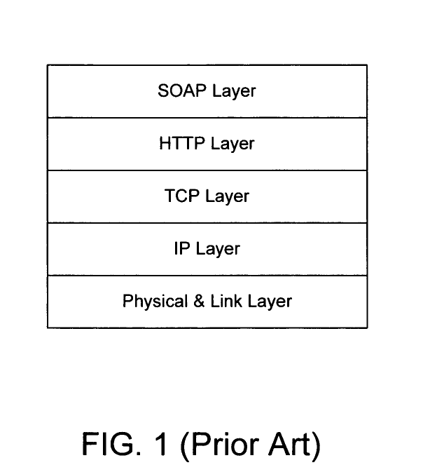

In the preferred embodiment, the messages are encoded in XML and packaged according to a standardized protocol, such as Simple Object Access Protocol (SOAP). SOAP is a web services wire protocol, layered on top of the network and transport layer as shown in FIG. 1. A SOAP protocol unit is called an envelope which has header information. The SOAP header includes information concerning how the message is to be processed and what route the message should take for that processing. Further, the SON administrator may have global policies concerning security, traffic engineering, session management etc. that may need to be applied to every transaction. Such policies can include routing and delivery settings, authentication or authorization assertions, and transaction context. Although the present invention is described as utilizing SOAP, other types of protocols can be used without departing from the spirit and scope of the present invention.

Semantic-Based Switch

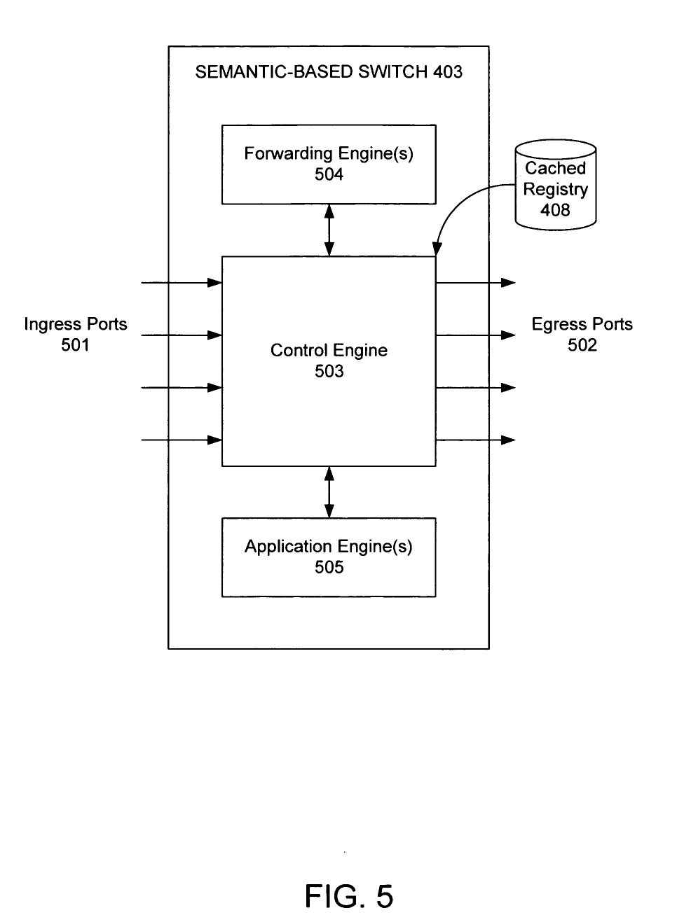

FIG. 5 illustrates a preferred embodiment of a semantic-based switch in accordance with the present invention. The switch 403 includes a control engine 503, one or more forwarding engines 504 with inline classification logic, and one or more application engines 505. The control engine 503 is responsible for performing layer 2 and layer 3 routing, and for inspecting the layer 4 headers for potential SOAP packets. Any potential SOAP packets are sent to the forwarding engine 504. The forwarding engine 504 is responsible for parsing the SOAP header, then splicing the Transmission Control Protocol (TCP) connection between the service requester 401 and an application engine 505. In addition, the forwarding engine 504 performs load balancing among multiple application engines 505 based on the current application engine load and on any policies to which a service requester has subscribed. The application engine 505 is responsible for matching and forwarding the SOAP request to the service providers. The application engine 505 is also responsible for possibly terminating the SOAP request and for load balancing among multiple service providers with the same functions. Similar to the forwarding engine 504, the load balancing is performed based on the current provider load and on any policies to which a service requester has subscribed.

Semantic-Based Switch Fabric Operating System

The features of the operating system comprises virtual addresses, service zoning, and web service management, as described below.

Virtual Addresses for Web Services

In the preferred embodiment of the semantic-based switch fabric operating system, each service registered with the switch fabric 402 is assigned or represented by a virtual address. During the publication phase, a service provider, such as content server AP2 407, publishes its service with a network registry. The registry parses the publication message from the service provider and assigns a virtual address to the service. During the discovery or find phase, the service requester 401 sends a service request to the registry. The registry returns to the service requester 401 a service description which comprises the virtual address assigned to the service.

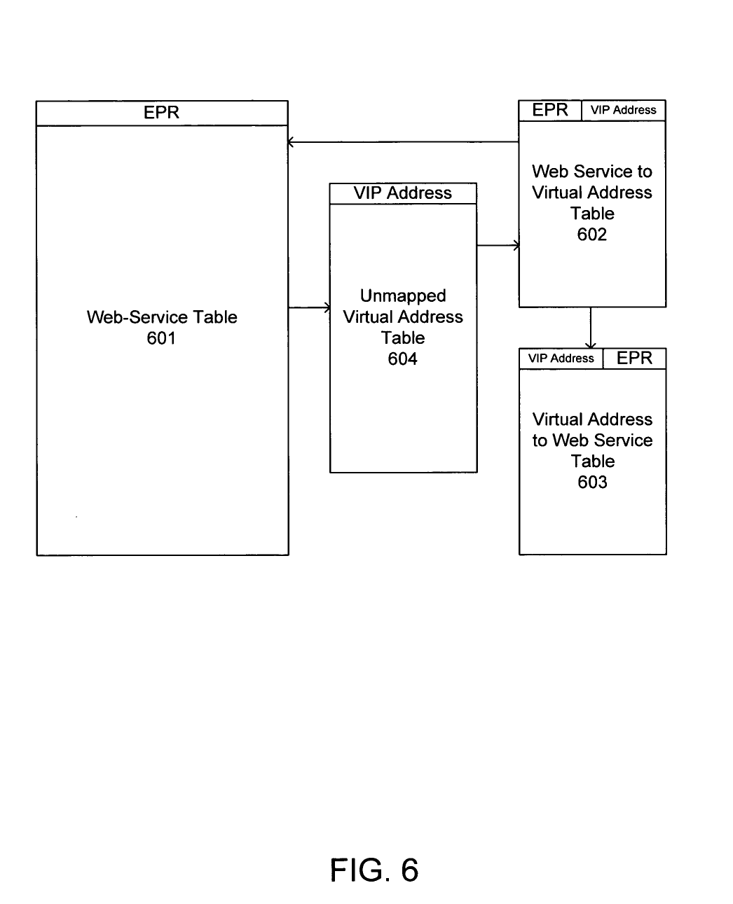

In the preferred embodiment, the mapping of services to virtual addresses are implemented utilizing a set of tables. FIG. 6 illustrates a preferred embodiment of the tables for managing virtual addresses in accordance with the present invention. The tables include a web services table 601 that contains a list of the web services registered with the network and a web service to virtual address table 602 containing a list of web services and their corresponding virtual addresses. During the discovery phase, a look-up is performed on the web service to virtual address table 602 in response to a service requester's requester for a service. The virtual address for a requested service according to this table 602 is then returned to the service requester 401.

The set of tables further includes an unmapped virtual address table 604, containing a list of virtual addresses not assigned to any web service. When a web service is registered and assigned a virtual address, this virtual address is removed from the unmapped virtual address table 604. When a service is deregistered, its virtual address is recycled by listing it again in the unmapped virtual address table 604. These tables are managed by the switch fabric operating system to avoid virtual address collisions.

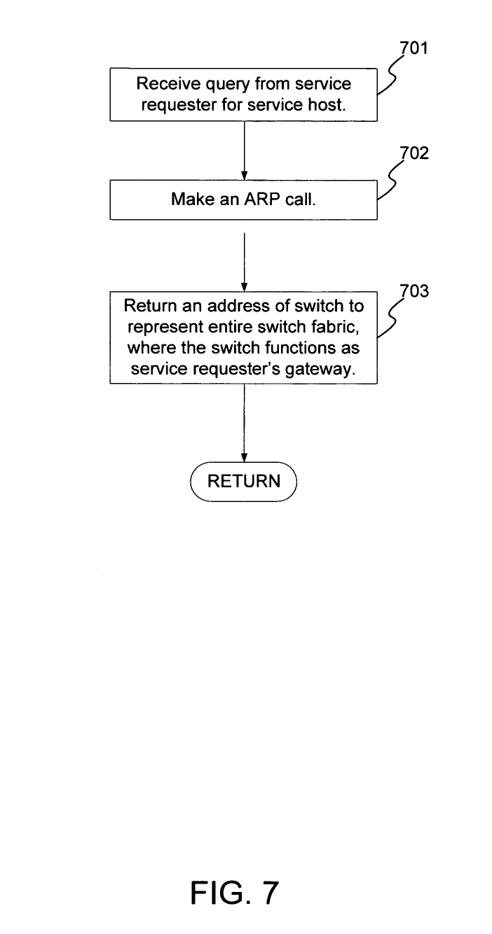

FIG. 7 is a flowchart illustrates the assignment of a gateway to a service requester by the switch fabric operating system. A service requester 401 sends an address resolution query to find the service host for a particular service Sa. When a switch 403 in the switch fabric receives the query from the service requester 401, via step 701, the switch 403 makes an address resolution call, via step 702. The address of one particular switch 405 to represent the switch fabric is then returned, via step 703. The switch 405 then functions as the gateway for the service requester 401. In this manner, the switch 405 is able to identify the service request without opening the SOAP messages. The switch fabric only needs to open the SOAP message once.

The service requester 401 then sends a message to the switch 405 using the virtual address in the envelope header. Thus, the service requester 401 accesses a service by sending a message to a virtual address assigned to the service, rather than to a physical address of a service provider. This virtual address is stored by the service requester 401, so that each time it wishes to access this service, the virtual address is used. Alternatively, a domain name can be used for the service, with the virtual address obtained from a domain name server (DNS). Reverse look-up tables are used to resolve the virtual address to the physical address of the service.

Next, the switch 405 performs a look-up on the virtual address to web service table 603 to determine the physical address for the service provider 407. The message is then routed to the switch 406 servicing the service provider 407, which sends the request in the message to the service provider 407.

To improve the performance further, the switch 406 may transform the message into remote procedure calls (RPC) directly and use them to communicate with the service provider. When the switch 406 is connected to a group of servers with the same service function, it acts as a proxy for the group of servers. The service requester 401 accesses the service by going through this proxy.

When the service provider 407 responds to the service requester 401, the switch 406 routes a message to the switch 405, and the switch 405 then sends the message to the service requester 401. In this manner, only the switch 405 is aware of the address for both the service requester 401 and the service provider 407. The service requester 401 is only aware of the virtual address for the service, while the service provider 407 is only aware of the address for the switch 405. Thus, the use of virtual addresses provides a layer of security. In addition, the service requester 401 need not be aware that the virtual address is “virtual”, as the virtual address is used by the service requester 401 in the same manner as the actual address for a service provider. The network thus is easily implemented with existing enterprises.

The routing of messages is further described in the co-pending U.S. patent applications titled, “Semantic-Based Grid Switch Apparatus”, Ser. No. 10/959,001, and “Semantic-Based Switch Fabric”, Ser. No. 10/958,883, both filed on Oct. 4, 2004 and assigned to the assignee of the present application. Applicant hereby incorporates these patent applications by reference.

Service-Oriented Architecture Stack

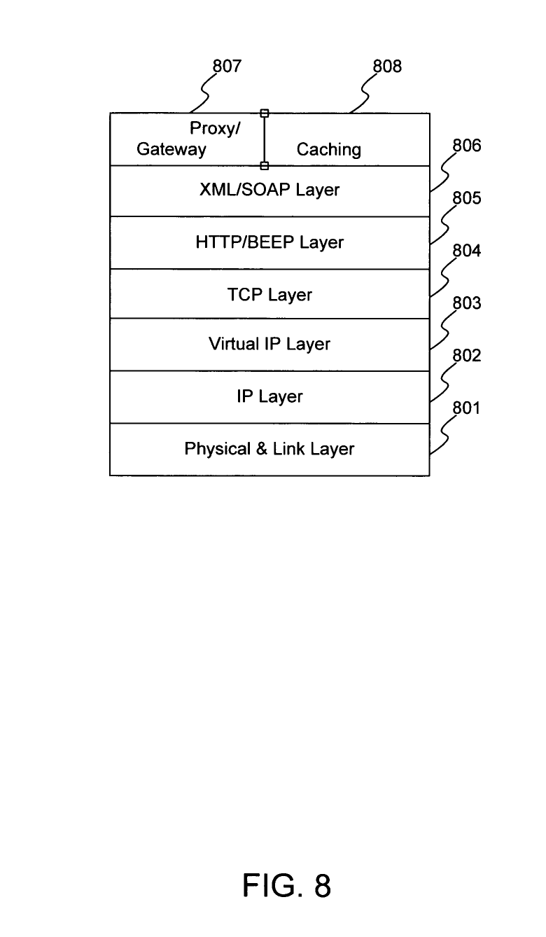

FIG. 8 illustrates a preferred embodiment of a service-oriented architecture stack in accordance with the present invention. Messages to be routed are processed according to this Service-Oriented Architecture (SOA) stack. The stack includes the physical and link layer 801, an IP layer 802 for routing based on a physical address, a virtual IP layer 803 for routing based on a virtual address, a transmission control protocol (TCP) layer 804, a transport protocol layer 805 (such as HTTP or BEEP), and a message protocol layer 806 (such as XML or SOAP). The stack further includes a proxy or gateway layer 807 that processes a message when a switch functions as a gateway for a service requester or a proxy for a service provider. The stack further includes a caching layer 808 for the caching of network information needed for switch functionalities.

In routing the message, the active intermediary switches parse the envelope header to find the routing information for the service. It is in this parsing process that the mapping of the service and the virtual address for the service are constructed. Once the mapping is constructed, the traffic in the bind phase does not need to parse the envelope header again. Thus, the virtual address enables the routing of messages at the Virtual IP layer 803. The parsing is therefore performed before the traffic is created, greatly improving network performance.

The semantic-based switch fabric operating system in accordance with the present invention enables both active and passive intermediary devices between the endpoint switches. A message is processed by an intermediary device only if it is acting as an active intermediary device. Otherwise, the intermediary device is passive, and the message passes through the device without any processing. The intermediary device also need not be a semantic-based switch 403, but can be a device of another type. The intermediary device can also be a device outside of the switch fabric 402, with the message later routed back within the switch fabric 402.

In the preferred embodiment, Blocks Extensible Exchange Protocol (BEEP) is used for inter-network communication. BEEP session resuse is used to save repeat TCP setup overhead. It is implemented in the session reuse and priority mechanisms in both the hardware and software in a switch 403 so that the SOAP processing performance is greatly improved over conventional BEEP implementations. It also provides backward compatibility with other protocols.

Service Zoning

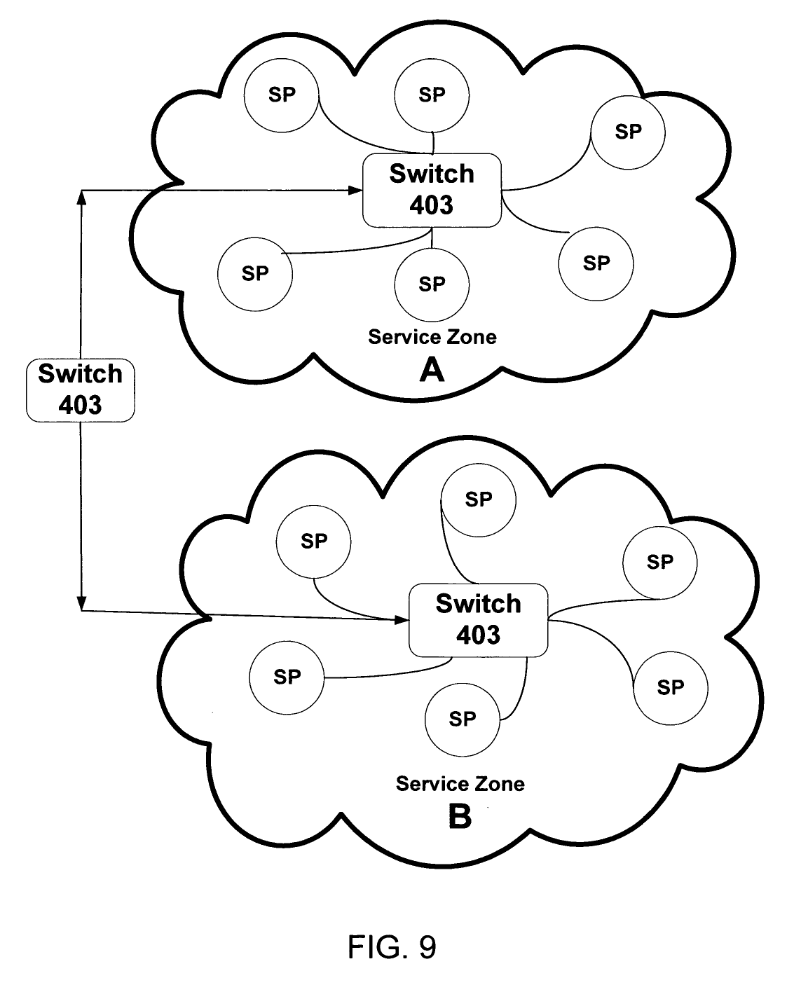

In the preferred embodiment, as illustrated in FIG. 9, the semantic-based switch fabric operating system is capable of classifying web services registered with the network into application or service zones. A zone is a grouping of web services, provided by service providers, as defined by function or policy. For example, Zone A can be a group of travel web services, with one application for booking car rental, another application for booking air travel reservations, and still another application for booking hotel reservations. Each zone is exposed to a service requester as a single entity or uniform resource locator (URL). A zone is thus an independent, autonomous domain with implementation independent interfaces to the rest of the network. Communication within the zone is managed by a semantic-based switch 403 in accordance with the present invention. When a service requester 401 is allowed access to one zone, it is not necessarily allowed access to another zone unless permitted by policy. A security wall is thus provided for a group of services. In this manner, management of the network is significantly distributed, improving the message routing speed and network performance within the zone.

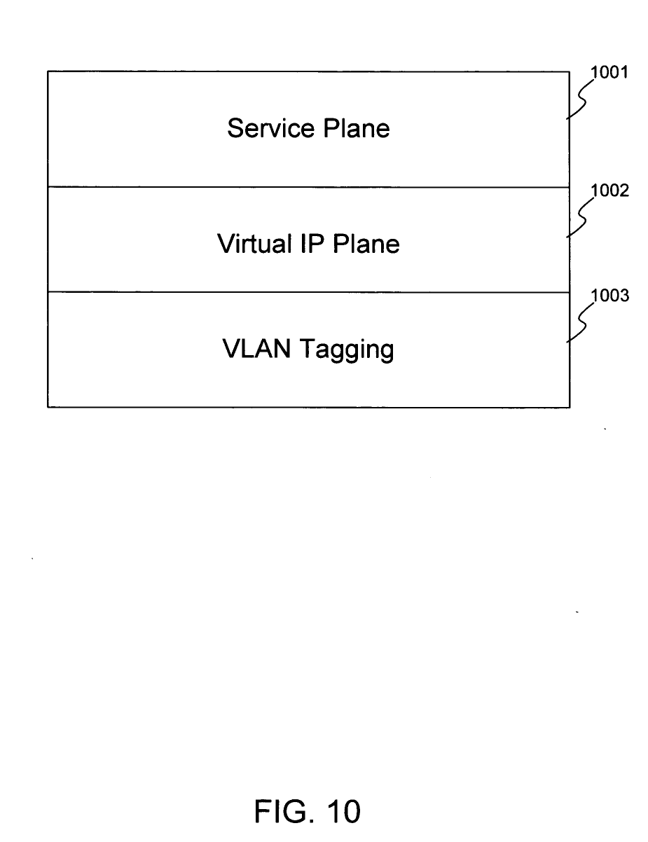

FIG. 10 illustrates the layers for enabling a service zone in accordance with the present invention. At the service plane 1001, web services are classified into zones. These web services are then mapped onto a virtual IP plane 1002, where the web services are assigned to virtual addresses, as described above. The virtual IP plane 1002 is overlaid onto an existing virtual local area network (VLAN) tagging plane 1003. Using the virtual addresses, routing is performed within a zone and between zones at the virtual IP or service planes 1001-1002.

Web Service Management

To assist in the management of the semantic-based switch fabric, the switch fabric operating system in accordance with the present invention includes several calls: WS-Ping, WS-Tracert, and WS-SPF.

WS-Ping is a call for pinging web services periodically to determine if they are still “alive” or active. If a web service does not respond to the WS-Ping call, then the operating system may deregister the web service. Unlike conventional Ping calls, which pings servers, WS-Ping pings web services.

WS-Tracert is a call for tracing a service requester to service provider route through the network. Unlike conventional Tracert calls, which traces host to host routes, WS-Tracert traces application to application routes.

WS-SPF is a call to determine the shortest path first. Unlike conventional SPF calls, which determines the shortest path based on the nearest node, WS-SPF determines the shortest path based on the nearest web service.

Network Application Server

In the preferred embodiment, the proxy and gateway functionality of the network are provided by a Network Application Server (NAS). The NAS runs inside a network device, such as the semantic-based switch 403. It provides the following services for the network: routing, transformation, gateway, security and policy, and management of different types of XML messages. The routing, transformation, and gateway functionalities are described above.

In providing the security and policy function, the NAS provides:

Centralized Policy Enforcement Point (PEP): the security policies of the service providers are off-loaded from the application servers and instead are implemented in a centralized manner by the semantic-based switch fabric operating system.

Dynamic runtime control of web services invocations: traffic can be routed based upon the over-subscription or under-subscription of certain service providers.

Generating message patterns for security analysis & reporting: since the switch fabric operating system provides endpoint to endpoint routing, any or all messages can be subject to analysis and reporting for security purposes.

Dynamic integration and virtualization of vertical services based upon policy: web services can be grouped vertically, where the grouping can be different for different service requesters, depending on their access based upon policy. For example, one service requester is allowed access to a zone of travel services but is limited to only hotel reservation services, while another service requester is allowed access to car rental, air travel reservations, and hotel reservation services.

Runtime creation of workflow systems based on policy to pipeline web services: different service requesters can be allowed to proceed to different levels in a series of services based upon policy. For example, one service requester is allowed to access an online catalog service, where the service requester can browse the catalog, place items in a shopping cart, and then purchase items with a credit card. However, another service requester is allowed only to browse the catalog.

Web service security proxy: for service providers that perform the same functions, the security functionality is off-loaded from the application servers onto the switch fabric operating system. This protects the application servers for both inbound and outbound messages.

Auditing of web service message at the network level: since the switch fabric provides endpoint to endpoint routing, any or all messages in the network can be monitored or audited.

Virtual IP protects server providers: since the physical address of a service provider is not exposed to service requesters due to the use of virtual addresses, any alterations to the virtual addresses, malicious or otherwise, does not directly affect the web services themselves.

Recycle of virtual IP addresses for security and lease expiration: to remove or deregister a web service from the network for security reasons or lease expiration reasons, the virtual address assigned to the web service can be recycled, i.e., listed in the unmapped virtual addresses table 604.

An operating system for providing an intelligent, semantic-based switch fabric has been disclosed. A operating system creates a semantic-based platform or fabric that provides a service oriented network. The operating system assigns virtual addresses to services registered with the network. Messages for the services are sent by service requesters using their virtual addresses. The virtual address is then mapped to the actual address of the service provider, which is then sent to the intended service provider. The messages are processed according to an SOA stack, which includes a virtual IP layer overlaid on an IP layer, a transport protocol layer, and a message protocol layer. The messages can be routed at the virtual IP, transport, or message layer without the need to process the message at the IP layer. The web services can be classified into a service zone, with the zone exposed to a service requester as a single entity. The zone is an independent domain, with communication within the zone managed by a semantic-based switch in the switch fabric.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

We claim:

1. A network, comprising:
a first table comprising a list of web services registered with a semantic-based switch fabric;
a second table comprising a list of virtual addresses assigned to the web services; and
a plurality of semantic-based switches, wherein each semantic-based switch provides an end-to-end connection between service requesters and service providers utilizing the virtual addresses.

2. The network of claim 1, wherein a first switch receives a message from a service requester comprising a virtual address assigned to a web service, wherein the first switch performs a look-up in the second table to obtain an address of a service provider assigned to the virtual address, wherein the first switch sends the message to the service provider.

3. The network of claim 1, further comprising a third table comprising a list of unmapped virtual addresses.

4. The network of claim 3, wherein when a web service deregisters from the network, a virtual address assigned to the web service is listed in the third table.

5. The network of claim 1, wherein one of the plurality of semantic-based switches is assigned to be a gateway for a service requester.

6. The network of claim 5, wherein the assigning of the gateway comprises:
receiving an address resolution query from the service requester;
making an address resolution call; and
returning an address of the gateway to represent the network to the service requester.

7. The network of claim 1, wherein a plurality of web services are classified into a service zone, wherein the service zone is exposed to the service providers as a single entity.

8. The network of claim 7, wherein the service zone is an independent domain, wherein communication within the service zone is managed by one or more semantic-based switches.

9. The network of claim 1, further comprising a WS-Ping call for pinging one or more web services.

10. The network of claim 1, further comprising a WS-Tracert call for tracing a route between a service requester and a service provider.

11. The network of claim 1, further comprising a WS-SPF call for determining a shortest path first between a service requester and a service provider.

12. A method for providing a service in a network, comprising:
registering a web service with the network, wherein the web service is listed in a first table of registered web services;
assigning to the web service a virtual address, wherein the web service and its assigned virtual address are listed in a second table;
receiving a web service request from a service requester;
obtaining from the second table the virtual address assigned to the requested web service; and
sending the virtual address to the service requester, wherein the service requester can send a message to a switch using the virtual address.

13. The method of claim 12, further comprising:
receiving the message by a first switch, wherein the message comprises the virtual address;
obtaining from the second table an address for a service provider of the web service assigned to the virtual address in the message; and
sending the message to a second switch servicing the service provider.

14. The method of claim 12, further comprising:
deregistering the web service from the network; and
listing the virtual address assigned to the web service in a third table of unmapped virtual addresses.

15. The method of claim 12, further comprising:
assigning the switch to function as a gateway to the network for the service requester.

16. The method of claim 15, wherein the assigning comprises:
receiving an address resolution query from the service requester;
making an address resolution call; and
returning an address of the switch to the service requester.

17. The method of claim 12, further comprising:
classifying one or registered web services into a service zone, wherein the service zone is exposed to the service provider as a single entity.

18. The method of claim 17, wherein the service zone is an independent domain, wherein communication within the service zone is managed by one or more semantic-based switches.

19. The method of claim 12, further comprising:
issuing a WS-Ping call for pinging one or more web services.

20. The method of claim 12, further comprising:
issuing a WS-Tracert call for tracing a route between the service requester and a service provider.

21. The method of claim 12, further comprising:
issuing g WS-SPF call for determining a shortest path between the service requester and a service provider.

22. An operating system stack, comprising:
a physical and link layer;
an Internet protocol layer;
a virtual internet protocol layer overlaid on the Internet protocol layer, wherein virtual addresses are assigned to web services registered with a semantic-based switch fabric;
a transmission control protocol layer;
a transport protocol layer; and
a message protocol layer.

23. The stack of claim 22, further comprising:
a proxy or gateway layer for processing a message when a semantic-based switch in the semantic-based switch fabric functions as a gateway for a service requester or as a proxy for a service provider; and
a caching layer for caching network information for switching functionalities.

24. The stack of claim 22, wherein a message is routed with processing at the message protocol layer without a need to process at the IP layer.

25. The stack of claim 22, wherein a message is routed with processing at the transport protocol layer without a need to process at the IP layer.

26. The stack of claim 22, wherein a message is routed with processing at the virtual IP layer without a need to process at the IP layer.
